(19) United States
(12) Patent Application Publication
(10) Pub. No.: US 2026/0145778 A1
(43) Pub. Date: May 28, 2026

(54) Control of Vertical Take Off and Landing Aircraft

(71) Applicant: Gaylord Olson, Morris Plains, NJ (US)

(72) Inventor: Gaylord Olson, Morris Plains, NJ (US)

(21) Appl. No.: 18/957,046

(22) Filed: Nov. 22, 2024

Related U.S. Application Data
(60) Provisional application No. 63/602,414, filed on Nov. 23, 2023.
(60) Provisional application No. 63/653,380, filed on May 30, 2024.

(51) Int. Cl. B64C 29/00; B64C 9/08; B64C 27/24

(52) U.S. Cl. CPC B64C 5/16; B64C 27/08; B64C 27/10; B64C 27/16; B64C 27/24; B64C 2027/8281

(57) ABSTRACT

Systems and methods for controlling the motion, flight, and stability of vertical takeoff and landing (VTOL) aircraft are disclosed. These systems employ four or more stabilators with airfoil cross-sections to redirect airflow from rotor blades, allowing independent adjustment for hover, roll, yaw, pitch, and forward or reverse movement. In one configuration, the VTOL aircraft transitions between helicopter and fixed-wing modes during flight, with stabilators augmenting lift in fixed-wing mode. Additional yaw control surfaces redirect thrust from engines to enhance maneuverability. The design enables low-cost, easily maintained VTOL aircraft capable of achieving forward speeds greater than those of traditional helicopters.

### CROSS-REFERENCE TO RELATED APPLICATIONS

This application claims priority to both U.S. provisional patent application U.S. 63/653,380 filed on May 30, 2024 entitled “Rotor jet and VTOL Concepts”, and to U.S. provisional patent application U.S. 63/602,412 filed on Nov. 23, 2023 entitled “Rotor jet Concepts” the contents of both of which are hereby fully incorporated by reference.

### BACKGROUND OF THE INVENTION

The invention relates to systems and methods for controlling the motion, flight and stability of vertical takeoff and landing (VTOL) aircraft, and more particularly to controlling the motion, flight and stability of aircraft capable of operating in both a helicopter mode of flight and a fixed wing mode of flight and of being able to transition between these modes while in flight.

Conventional helicopters typically have a maximum forward speed of about 170 to 230 mph. The main limit on the forward speed of helicopters is retreating blade stall caused by the retreating blade moving with the airflow. This results in a reduction in relative air speed of the retreating blade as the forward speed of the helicopter increases, and a therefore a loss of lift, with the blade eventually stalling near the maximum forward speed.

What is desirable is a VTOL that may take off in helicopter mode and then transition to a fixed wing mode of flight in which there is no retreating blade stall. Attempts to implement such an aircraft have been hindered by helicopter's using a swashplate as part of their fight control system. The swashplate is connected directly to the main rotor shaft and allows the pilot to manipulate the blades to control lift, direction and stability. The swashplate is a relatively complex mechanism and its situation on the main rotor shaft hinders transitioning rotor blades into fixed wing airfoils.

What is desirable is a method of controlling the motion, flight and stability of a helicopter that avoids the use of a swashplate. Such an innovation would allow for aircraft capable of operating in both a helicopter mode of flight and a fixed wing mode of flight and of being able to transition between these modes while in flight.

Relevant prior art includes:
U.S. Pat. No. 8,070,090 entitled “ Stop-rotor rotary wing aircraft” issued to Steven K. Tayman on 2011 Dec. 6 that describes systems and methods for transitioning an aircraft between helicopter and fixed wing flight modes. In one embodiment, an aircraft comprises a plurality of wings each having a spar and a flap; a flap actuator configured to move the flap with respect to the spar; and a center section rotatably coupled to each spar. The center section includes at least one spar actuator configured to rotate at least one of the wings about a rotational axis of the spar when the aircraft transitions between helicopter and fixed wing flight modes.
U.S. Pat. No. 9,616,995 entitled “Aircraft and methods for operating an aircraft” issued to Rowan John Watkins on 2017 Apr. 11 that describes an aircraft comprising a fuselage having a longitudinal axis, at least one helicopter main rotor operably mounted to the fuselage, the at least one helicopter main rotor comprising rotor blades rotatable about a rotation axis, wherein the rotor blades can be stopped in flight and adapted to provide symmetrical wing surfaces relative to the longitudinal axis; and the aircraft having at least one control surface operable to provide a relative airflow in flight substantially aligned with the rotation axis of the at least one helicopter main rotor.
U.S. Pat. No. 10,421,538 entitled “Rotary wing VTOL with fixed wing forward flight mode” issued to Joseph B. Seale et al. on 2019 Sep. 24 that describes aircraft's two wings and joined thruster propellers or turbines serve as rotary wings in helicopter mode and as fixed wings in airplane mode. The thrusters along the wingspans or at the wing tips drive both rotary wing rotation and airplane flight. Large angle controlled feathering about the pitch change axes of the left and right wings and thrusters allows them to rotate, relative to each other, between facing and thrusting forward in the same direction for airplane flight or facing and thrusting oppositely for helicopter flight. Optional controls include helicopter cyclic and collective pitch; airplane roll by differential wing pitch; yaw by differential prop thrust; fuselage pitch by wing pitch change and prop thrust change interacting with an underslung craft e.g.; and fuselage yaw control independent of rotor rotation via a powered rotary mast coupling or a tail responsive to rotor downwash. A teetering rotor hub is a further option.

Various implementations are known in the art, but fail to address all of the problems solved by the invention described herein. Various embodiments of this invention are illustrated in the accompanying drawings and will be described in more detail below.

### SUMMARY OF THE INVENTION

Inventive systems and methods of controlling the motion, flight and stability of vertical takeoff and landing (VTOL) aircraft are disclosed.

The control may, for instance, be accomplished using four or more stabilators to redirect the downward airflow from one or more rotor blades powered to provide vertical lift. These stabilators may have airfoil cross sections and may be independently adjusted so as to control the hover, roll, yaw and pitch of the aircraft, as detailed below. They may also be used to provide forward or reverse movement of the aircraft.

In a preferred embodiment, the aircraft may be capable of both a helicopter mode of operation and a fixed wing mode of operation, and may be capable of making the transition between modes while in flight.

In the fixed wing mode of operation, the stabilators may be adjusted to augment the lift provided either by fixed rotor blades or conventional wings.

In a further embodiment, the system may include additional yaw control surfaces that may redirect the thrust from one or more engines providing forward thrust to the aircraft.

Therefore, the present invention succeeds in conferring the following, and others not mentioned, desirable and useful benefits and objectives.

It is an object of the present invention to provide low cost, easily maintained VTOL aircraft.

It is another object of the present invention to provide a VTOL aircraft that is capable of forward speeds in excess of those achievable by helicopters.

### BRIEF DESCRIPTION OF DRAWINGS

FIG. 1A shows a schematic side elevation view of an aircraft capable of a helicopter mode of flight.

FIG. 1B shows a schematic plan view of the aircraft depicted in FIG. 1A.

FIG. 1C shows a schematic front view of the aircraft depicted in FIGS. 1A and 1B.

FIG. 2A shows a schematic side elevation view of an aircraft capable of helicopter and fixed wing modes of flight in helicopter mode.

FIG. 2B shows a schematic plan view of the aircraft shown in FIG. 2A in helicopter mode.

FIG. 2C shows a schematic front view of the aircraft shown in FIGS. 2A and 2B in helicopter mode.

FIG. 3A shows a schematic side elevation view of an aircraft capable of helicopter and fixed wing modes of flight in fixed wing mode

FIG. 3B shows a schematic plan view of the aircraft shown in FIG. 3A in fixed wing mode.

FIG. 3C shows a schematic front view of the aircraft shown in FIGS. 3A and 3B in fixed wing mode

FIG. 4A shows a schematic side elevation view of a rotor jet powered aircraft capable of helicopter and fixed wing modes of flight in helicopter mode.

FIG. 4B shows a schematic plan view of the aircraft shown in FIG. 4A in helicopter mode.

FIG. 4C shows a schematic front view of the aircraft shown in FIGS. 4A and 4B in helicopter mode.

FIG. 5A shows a schematic side elevation view of a rotor jet powered aircraft capable of helicopter and fixed wing modes of flight in fixed wing mode.

FIG. 5B shows a schematic plan view of the aircraft shown in FIG. 5 A in fixed wing mode.

FIG. 5C shows a schematic front view of the aircraft shown in FIGS. 5A and 5 B in fixed wing mode.

FIG. 6 shows a schematic plan view of a blown blade powered aircraft capable of helicopter and fixed wing modes of flight in helicopter mode.

FIG. 7A shows a schematic side elevation view of a tandem rotor aircraft capable of helicopter and fixed wing modes of flight in helicopter mode.

FIG. 7B shows a schematic plan view of the aircraft shown in FIG. 7A in helicopter mode.

FIG. 7C shows a schematic front view of the aircraft shown in FIGS. 7A and 7B in helicopter mode.

### DETAILED DESCRIPTION OF THE INVENTION

The preferred embodiments of the present invention will now be described with reference to the drawings. Identical elements in the various figures are identified, in so far as possible, with the same reference numerals. The embodiments that are described in detail are provided by way of explanation of the present invention, which is not intended to be limited thereto. In fact, those of ordinary skill in the art may appreciate upon reading the present specification and viewing the present drawings that various modifications and variations can be made thereto.

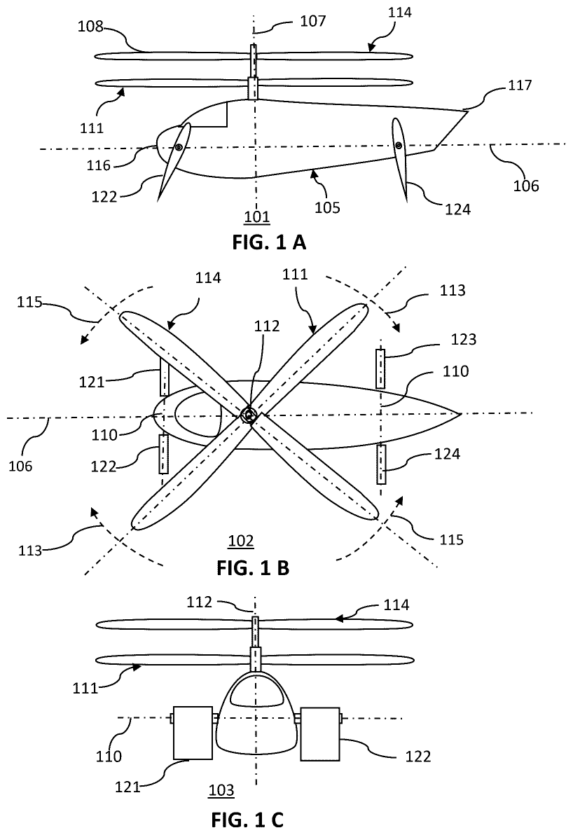

FIG. 1A shows a schematic side elevation view 101 of an aircraft capable of a helicopter mode of flight.

Lift may be provided to the aircraft by a plurality of airfoil blades 108 that may be powered to rotate about a vertical axis 107 of the aircraft's fuselage 105, the vertical axis 107 being perpendicular to the longitudinal axis 106 of the fuselage. There may, for instance, be two sets of airfoil blades, a first pair 111 and a second pair 114. These pairs of blades may be powered to rotate in opposite directions, thereby avoiding any net torque being transferred to the fuselage, and meaning that there is no need for a tail rotor as in a conventional helicopter. The power unit may be any reasonably powerful power unit such as, but not limited to, a turboshaft engine, a reciprocating piston engine, an electric motor, or some combination thereof.

In order to provide lift to the aircraft, the airfoil blades may be configured to direct airflow vertically downwards. The aircraft may be controlled in pitch, yaw and roll by redirecting this downward airflow using four or more stabilators. In FIG. 1A, two of these stabilators are shown, a forward port stabilator 122 and a rear port stabilator 124. The first may be located towards the front 116 of the aircraft's fuselage, and the second to the rear 117 of the fuselage. The stabilators may have airfoil cross-sections in order to more efficiently redirect the downward airflow. Controlling the stability of the aircraft by using stabilators may avoid the need for swashplates to control the rotating blades.

FIG. 1B shows a schematic plan view 102 of the aircraft shown in FIG. 1A.

As shown in FIG. 1B, a first pair 111 of airfoil blades may be powered to rotate about a rotational axis 112 in a clockwise direction 113, while a second pair 114 of airfoil blades may be powered to rotate about the same rotational axis in a counterclockwise direction 115.

The downward airflow produced by the rotating airfoil blades may be redirected by four or more stabilators to control the aircraft. These stabilators may be configured to be independently moveable about one or more axis 110 protruding laterally from fuselage, the axis being perpendicular to both the longitudinal axis 106 and the vertical axis the aircraft's fuselage. (The vertical axis may be parallel to, and possibly collocated with the rotational axis 112). This movement may, for instance, be provided by a motor such as, but not limited to, an electrical motor, or an electrical stepper motor.

Stabilators may initially be in a neutral position, pointing vertically downward. When adjusted away from the neutral position, they may begin to generate lateral thrust. However, that lateral thrust may result in increased drag on the stabilator that may result in a downward force on the aircraft. This change in downward force may be used to control the stability of the aircraft, including its ability to hover and adjust for pitch, yaw and roll.

For instance, to hold the aircraft stationary, or hover, all four stabilators may be held in a neutral position, which may be pointing vertically down, or they may be adjusted to all be providing a small but equal thrust directed towards the center of the fuselage.

To provide a clockwise roll, i.e., clockwise when looking forward along the longitudinal axis 106, the starboard side stabilators, i.e. forward starboard stabilator 121 and rear starboard stabilator 123, may be adjusted to provide an equal thrust towards each other, but more than an equal thrust towards each other provided by the port side stabilators, i.e., forward port stabilator 122 and rear port stabilator 124. This may result in a net downward thrust on the starboard side of the aircraft resulting in a roll about the longitudinal axis 106.

Similarly, a counterclockwise roll may be achieved by having the portside pair of stabilators provide more thrust towards each other than the starboard pair.

The degree, or rate of roll, may, for instance, be controlled by adjusting the difference in total force between the pairs. This control of the roll rate may, for instance, be mediated by suitably programmed computer software.

Providing a clockwise yaw, i.e., clockwise when looking down along the rotational axis 112, may be accomplished in a number of ways.

The forward port stabilator 122 may be adjusted to provide forward thrust, while the forward starboard stabilator 121 may be adjusted to provide thrust directed to the rear, while two rear stabilators may both be adjusted to provide either enough forward or rear thrust to minimize any pitching of the aircraft.

Alternately, the rear starboard stabilator 123 may be adjusted to provide rearward thrust, while rear port stabilator 124 may be adjusted to provide forward thrust, while the forward stabilators are adjusted to provide enough forward or rear thrust to minimize pitching of the aircraft.

Other configurations for clockwise yaw may include forward port stabilator 122 thrusting forward while rear starboard stabilator 123 thrusts rearward, with the other two stabilators adjusted to minimize pitch, or simply having both port stabilators 122 and 124 providing forward thrust and both starboard stabilators 121 and 123 providing rearward thrust.

There may be a variety of other options that involve stabilators acting independently.

Forward pitching of the aircraft, i.e., the front of the aircraft dipping down, may, for instance, be accomplished by having the two forward stabilators, 121 and 122, provide more forward thrust than the rear pair of stabilators, 123 and 124. This may seem counter intuitive, but the increase in thrust results in an increase in drag, and since the stabilators are effectively acting perpendicularly down with respect to the longitudinal axis 106 of the aircraft, the extra drag will result in a downward force on the front of the fuselage.

Pure forward motion of the aircraft may be achieved by having all four stabilators providing an equal amount of thrust in a forward direction. Similarly rearward motion may be achieved by having all four stabilators provide an equal amount of thrust in a rearward direction.

One of ordinary skills in the art may readily appreciate that adjustment to roll, yaw and pitch may be achieved by controlling the stabilators appropriately according to the descriptions above.

Control of the aircraft using stabilators may be complex but may be achieved by a suitably programmed computer software mediating pilot requests. This software may, for instance, include a neural network that may be trained on scale or full-size models either in wind tunnels or while suitably tethered.

FIG. 1C shows a schematic front view 103 the aircraft shown in FIGS. 1A and 1B.

A second pair 114 of airfoil blades may be located vertically above a first pair 111 of airfoil blades, both functionally connected to be rotationally powered around a common rotational axis 112, but in opposite directions. In that manner, no net rotational torque may be transferred to the aircraft fuselage. The airfoil blades may be designed and configured to provide a downward airflow, and therefore upward thrust to the aircraft.

Two of four stabilators, i.e., forward starboard stabilator 121 and the forward port stabilator 122, are visible in FIG. 1C. These are configured to be moveable about an axis 110 protruding laterally from the fuselage, and being perpendicular to both the rotational axis 112 and the longitudinal axis of the aircraft's fuselage.

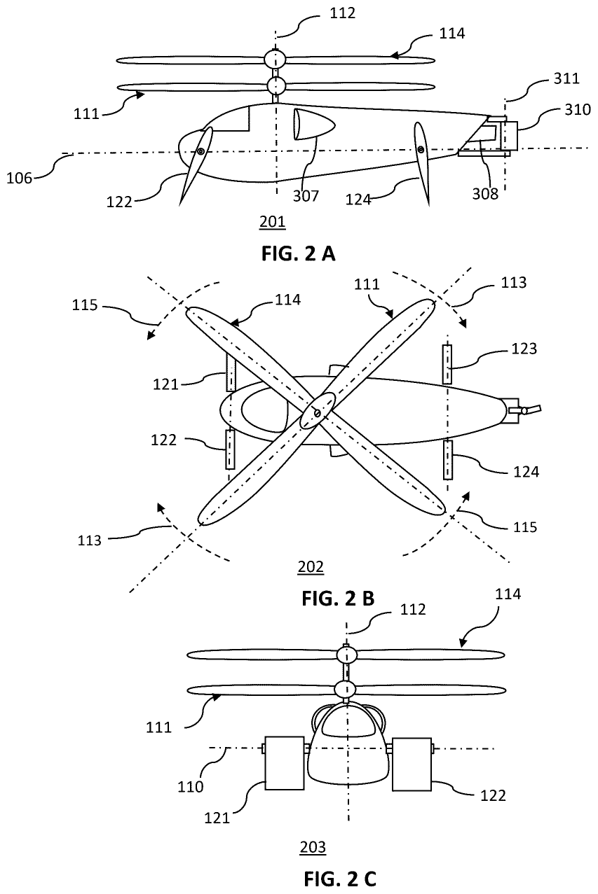

FIG. 2A shows a schematic side elevation view 201 of an aircraft capable of helicopter and fixed wing modes of flight in helicopter mode.

The aircraft of FIG. 2A may have vertical lift provided by two sets of counter-rotating airfoil blades. The first and second pair of airfoil blades 111 and 114, may be mounted vertically above each other on a common rotational axis 112. The rotation axis may be parallel to a vertical axis of the aircraft and may be collocated with it.

The aircraft may be held stable and hovered, or maneuvered in roll, yaw and pitch by means of four or more stabilators, two of which are shown in FIG. 2A, namely forward port stabilator 122 and rear port stabilator 124. This maneuverability may be accomplished as discussed above.

Also shown in FIG. 2A are an air intake 307 and an exhaust 308 of an engine. This engine may be used to power the rotation of the counter-rotating sets of blades, or it may be reserved for use when the aircraft is in a fixed wing mode of flight. Also shown are a yaw control surface 310 that may be moved about a yaw control axis 311. These may be reserved for use in the fixed wing mode of flight.

FIG. 2B shows a schematic plan view 202 of the aircraft shown in FIG. 2A in helicopter mode.

The first pair 111 of said airfoil blades may be powered to rotate in a clockwise direction 113, while a second pair 114 of said airfoil blades may be powered to rotate in a counterclockwise direction 115. Together these counter rotating sets of airfoil blades provide lift to the aircraft by directing a stream of air downwards.

The four stabilators, i.e., the forward starboard stabilator 121, the forward port stabilator 122, the rear starboard stabilator 123 and the rear port stabilator 124, provide stability and maneuverability to the aircraft by redirecting this downward airflow, as described in more detail above.

FIG. 2C shows a schematic front view 203 the aircraft shown in FIGS. 2A and 2B in helicopter mode.

As shown in FIG. 2C, a first pair 111 of airfoil blades and a second pair 114 of airfoil blades separated vertically but configured to rotate about a common rotational axis 112 that may be parallel to the vertical axis of the airplane fuselage. These provide the lift by generating a downward steam of air.

Four stabilators provide maneuverability and stability by redirecting this downward airflow. Two of them, the forward starboard stabilator 121 and the forward port stabilator 122 are shown in a neutral, or near neutral, position, rotated approximately vertically down about an axis 110 that may protrude laterally from the fuselage, and may be oriented perpendicular to the rotational axis 112.

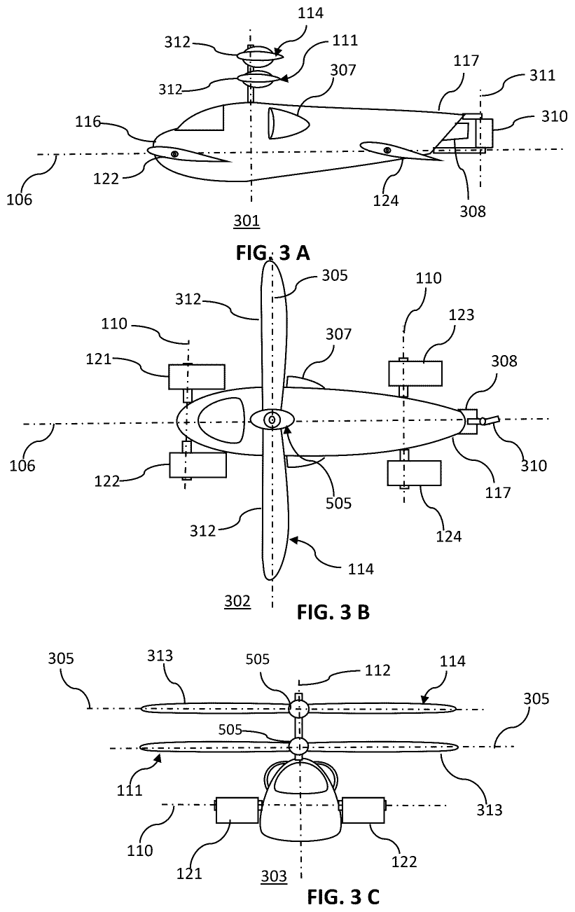

FIG. 3A shows a schematic side elevation view 301 of an aircraft capable of helicopter and fixed wing modes of flight in fixed wing mode of flight.

Both the first pair 111 and second pair 114 of airfoil blades may have been stopped from rotating and may now be held stationary and positioned with a long axis of each of the airfoil blades oriented perpendicular to both the longitudinal axis and the vertical axis of the aircraft fuselage.

In addition, one airfoil blade of each of the pairs may have been rotated such that all their leading edges 312 now face toward the front 116 of the fuselage. This approximately 180-degree rotation may have been accomplished by a geared assembly 505 that may be powered by an electrical motor.

The aircraft may also have a power unit to provide additional thrust for the fixed wing mode of flight such as, but not limited to, a turboshaft or a jet engine, or some combination thereof. The air intake 307 and the exhaust 308 of such an engine are depicted.

The aircraft may additionally have a yaw control surface 310 located at the rear 117 of the fuselage. This yaw control surface 310 may be controllable angled about a yaw control axis 311 in order to redirect the stream of hot gas flowing out of the exhaust of the engine, thereby acting as a vectored thrust to help control yaw in forward, fixed wing flight.

The stabilators may now have been oriented to lie nearly parallel to the longitudinal axis 106 and may act as airfoils to assist in providing lift, as depicted by the forward port stabilator 122 and rear port stabilator 124.

FIG. 3B shows a schematic plan view 302 of the aircraft shown in FIG. 3A in fixed wing mode.

The airfoil blades may have been stopped from rotating and may now be held stationary and positioned with a long axis 305 of each of the airfoil blades oriented perpendicular to both the longitudinal axis 106 and the vertical axis of the aircraft fuselage.

In addition, one airfoil blade of each of the pairs may have been rotated such that all their leading edges 312 now face toward the front 116 of the fuselage. This approximately 180-degree rotation may have been accomplished by a geared assembly 505 that may be powered by an electrical motor.

The aircraft may also have a power unit to provide additional thrust for the fixed wing mode of flight such as, but not limited to, a turboshaft or a jet engine, or some combination thereof. The air intake 307 and the exhaust 308 of such an engine are depicted.

The aircraft may additionally have a yaw control surface 310 located at the rear 117 of the fuselage. This yaw control surface 310 may be controllable angled about a yaw control axis in order to redirect the stream of hot gas flowing out of the exhaust of the engine, thereby acting as a vectored thrust to help control yaw in forward, fixed wing flight.

The stabilators may now have been oriented to lie nearly parallel to the longitudinal axis 106 and may act as airfoils to assist in providing lift, as depicted by the forward starboard stabilator 121, the forward port stabilator 122, the rear starboard stabilator 123 and the rear port stabilator 124.

FIG. 3C shows a schematic front view 303 of the aircraft shown in FIGS. 3A and 3B in fixed wing mode.

In each of the pairs of airfoil blades 114 and 111, there may be one rotated airfoil blade 313 that has been rotated approximately 180 degrees about a long axis 305 of the airfoil blade so that the leading edges of all the airfoil blades are now oriented towards the front of the fuselage, thereby providing more effective lift for fixed wing flight. This rotation may have been effected in flight by a geared assembly 505 that may be powered by an electric motor.

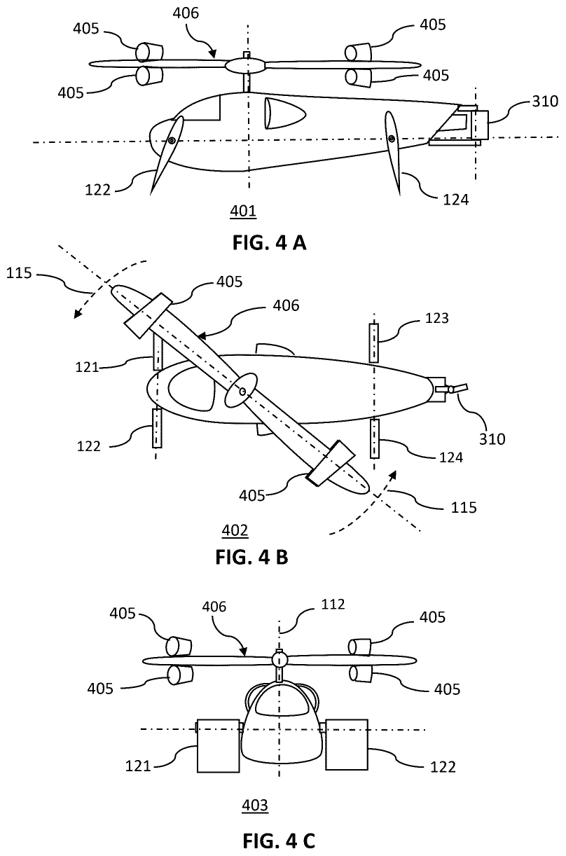

FIG. 4A shows a schematic side elevation view 401 of a rotor jet powered aircraft capable of helicopter and fixed wing modes of flight in helicopter mode

A key difference between the aircraft shown in FIG. 4A and that shown in FIG. 2A is that now there may only be a single pair of airfoil blades 406. This single pair of airfoil blades may be driven to rotate and provide thrust by four or more thrust units 405 that may be located on the airfoil blades themselves, in what is conventionally termed a rotor jet mode. This method of powering the rotor blades may result in no net torque being transferred to the aircraft fuselage.

The thrust units 405 may be any suitable small power unit such as, but not limited to, small jet engines, small electrically driven propellor units or some combination thereof. If the jets are at or near the blade tips, only two of them may be required. There are well-known examples of such rotor jet powered helicopters.

The aircraft in FIG. 4A may have all the same control and maneuvering elements as the aircraft depicted in FIG. 2A, such as the stabilators and yaw control surface. These are depicted as the forward port stabilator 122, the rear port stabilator 124 and the yaw control surface 310.

FIG. 4B shows a schematic plan view 402 of the aircraft shown in FIG. 4 A in helicopter mode.

As shown, a single pair of airfoil blades 406 may be powered to rotate in a counterclockwise direction 115 by a plurality of thrust units 405 in what is termed a rotor jet mode, and may thereby provide lift to the aircraft with no net torque being transferred to the aircraft fuselage.

The aircraft in FIG. 4B may have all the same control and maneuvering elements as the aircraft depicted in FIG. 2B, such as the stabilators and yaw control surface. These are depicted as the forward starboard stabilator 121. the forward port stabilator 122, rear starboard stabilator 123, the rear port stabilator 124 and the yaw control surface 310.

FIG. 4C shows a schematic front view 403 the aircraft shown in FIGS. 4 A and 4 B in helicopter mode.

A single pair of airfoil blades 406 is depicted being powered to rotate about a rotational axis 112 by four thrust units 405.

The aircraft in FIG. 4C may have all the same control and maneuvering elements as the aircraft depicted in FIG. 2C, such as the stabilators and yaw control surface. These are depicted as the forward starboard stabilator 121 and the forward port stabilator 122.

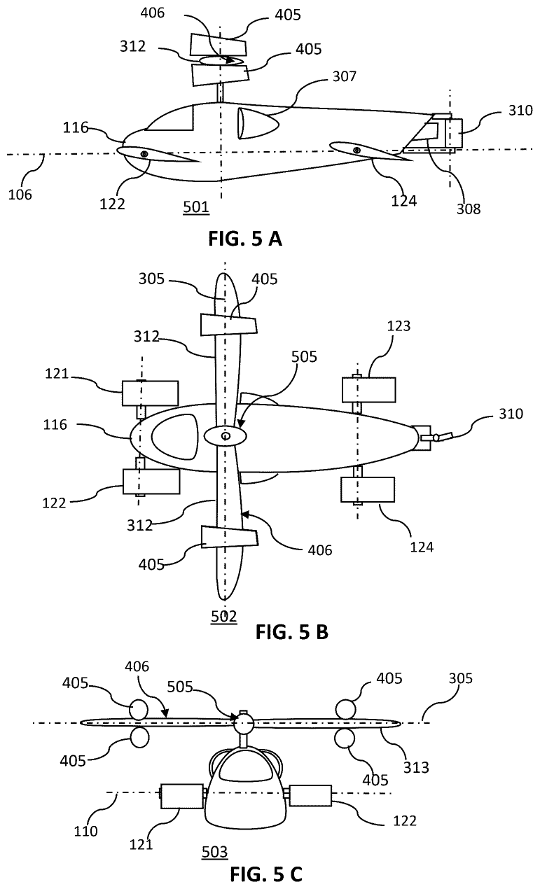

FIG. 5A shows a schematic side elevation view 501 of a rotor jet powered aircraft capable of helicopter and fixed wing modes of flight in fixed wing mode.

One significant difference between the aircraft shown in FIG. 5A and that shown in FIG. 3A is that now there may only be a single pair of airfoil blades 406. A second may be that there may now be a plurality of thrust units 405 mounted on the single pair of airfoil blades. These thrust units may provide all of the power for forward fixed wing flight, or they may be augmented by a conventional power unit such as, but not limited to, a turboshaft or a jet engine, or some combination thereof. The air intake 307 and the exhaust 308 of such an engine are depicted.

The aircraft shown in FIG. 5A and that shown in FIG. 3A may have all the same control surfaces such as, but not limited to, the stabilators and yaw control surfaces, as depicted by the forward port stabilator 122, the rear port stabilator 124 and the yaw control surface 310.

As shown in FIG. 5A, the stabilators may be oriented approximately parallel to the longitudinal axis 106 in order to act more like conventional aircraft wings and provide additional lift.

FIG. 5B shows a schematic plan view 502 of the aircraft shown in FIG. 5 A in fixed wing mode of flight.

The single pair of airfoil blades 406 may now be held stationary and positioned with a long axis 305 of the airfoil blades oriented perpendicular to both the longitudinal axis and the vertical axis of said fuselage. In order for all the thrust units 405 on the single pair of airfoil blades 406 to be oriented so that their thrust is directed toward the front 116 of the fuselage, one of the airfoil blades may have been rotated by approximately 180 degrees about the long axis 305 of the airfoil blades. This approximately 180-degree rotation may have been accomplished by a geared assembly 505 that may be powered by an electrical motor.

The aircraft shown in FIG. 5B and that shown in FIG. 3B may have all the same control surfaces such as, but not limited to, the stabilators and yaw control surfaces, as depicted by forward starboard stabilator 121, the forward port stabilator 122, rear starboard stabilator 123, the rear port stabilator 124, and the yaw control surface 310.

FIG. 5C shows a schematic front view 503 of the aircraft shown in FIGS. 5A and 5B in fixed wing mode of flight.

In order for all of the thrust units 405 to be providing thrust in the same direction, one of the airfoil blades 313 on the single pair of airfoil blades 406 may be rotated by approximately 180 degrees around the long axis 305 of the airfoil blades. This approximately 180-degree rotation may have been accomplished by a geared assembly 505 that may be powered by an electrical motor.

The aircraft shown in FIG. 5C and that shown in FIG. 3C may have all the same control surfaces such as, but not limited to, the stabilators and yaw control surfaces, as depicted by forward starboard stabilator 121 and the forward port stabilator 122. These stabilators may have been rotated about an axis 110 protruding laterally from said fuselage to be oriented approximately parallel to the longitudinal axis in order to act more like conventional aircraft wings and provide additional lift.

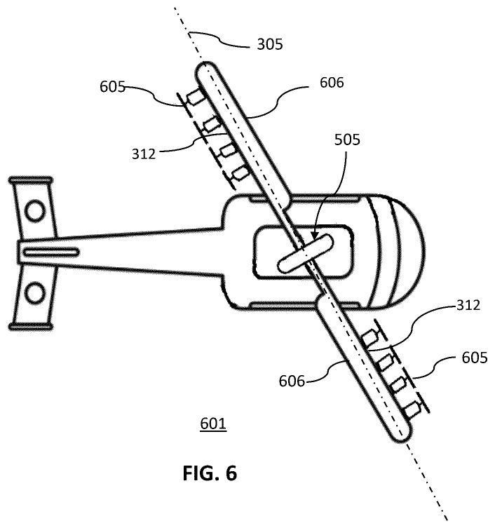

FIG. 6 shows a schematic plan view 601 of a blown blade powered aircraft capable of helicopter and fixed wing modes of flight in helicopter mode.

The aircraft depicted in FIG. 6 differs from the rotor jet powered aircraft shown in, for instance, FIG. 4B, in that the thrust may now be provided by one or more electric motor powered airplane propellors 605 that may be mounted forward of the leading edge 312 of each of the airfoil blades 606. An advantage of such an arrangement may be that the propellors provide additional airflow across the airfoil blades thereby providing additional lift.

Also shown is the geared assembly 505 that may be used to rotate one of the airfoil blades 180 degrees about the long axis 305 should the aircraft be designed to transition in flight to fixed wing mode of flight. This may, for instance, be accomplished by a geared assembly that may be powered by an electrical motor.

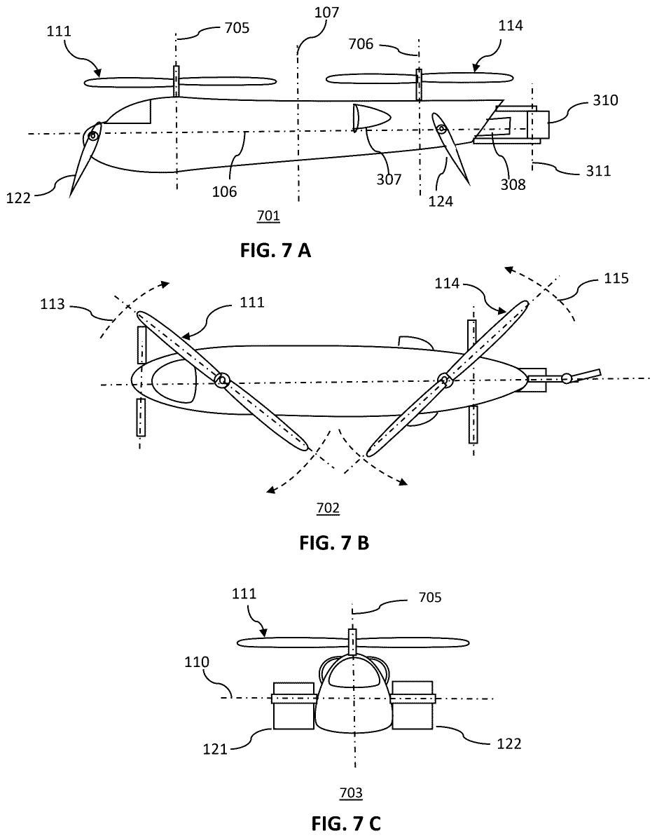

FIG. 7A shows a schematic side elevation view 701 of a tandem rotor aircraft capable of helicopter and fixed wing modes of flight in helicopter mode.

The aircraft has two counter-rotating pairs of airfoil blades 111 and 114, each rotating about a separate rotational axis. The second rotational axis 706 may be located laterally removed from the first rotational axis 705 along said longitudinal axis 106 of said fuselage, and each rotational axis may be substantially parallel to a vertical axis 107 of the fuselage.

The aircraft in FIG. 7A may have all the same control and maneuvering elements as the aircraft depicted in FIG. 2A, such as the stabilators and yaw control surface. These are depicted as the forward port stabilator 122, the rear port stabilator 124 and the yaw control surface 310.

The aircraft may also have one or more power units to provide thrust for a fixed wing mode of flight such as, but not limited to, a turboshaft or a jet engine, or some combination thereof. The air intake 307 and the exhaust 308 of such an engine are depicted. The power units may also, or instead be located on the outside rear of the fuselage.

FIG. 7B shows a schematic plan view 702 of the aircraft shown in FIG. 7A in helicopter mode of flight.

A first pair 111 of airfoil blades is depicted being powered to rotate in a clockwise direction 113 while a second pair 114 of airfoil blades may be powered to rotate in a counterclockwise direction 115. The counter rotating pairs of blades may allow for no net torque to be transferred to the aircraft fuselage.

FIG. 7C shows a schematic front view 703 the aircraft shown in FIGS. 7A and 7B in helicopter mode.

The figure depicts a first pair 111 of airfoil blades being powered to rotate about a first rotational axis 705. Also shown are a forward starboard stabilator 121 and a forward port stabilator 122, both of which may be in a neutral position, pointing approximately vertically downwards.

Although this invention has been described with a certain degree of particularity, it is to be understood that the present disclosure has been made only by way of illustration and that numerous changes in the details of construction and arrangement of parts may be resorted to without departing from the spirit and the scope of the invention.

1. An aircraft capable of a helicopter mode of flight and having yaw, pitch and roll controls in flight, said aircraft comprising:
a fuselage having a front, a rear, a port side, a starboard side, wherein said fuselage has a longitudinal axis that extends from said front to said rear, and a vertical axis that is perpendicular to said longitudinal axis of said fuselage;
rotor blades that when in said helicopter mode rotate about a rotational axis substantially parallel to said vertical axis, therein producing a downwash of air that passes over and around said fuselage;
a forward port stabilator that is independently movable about a first axis, wherein said forward port stabilator extends from said port side of said fuselage at a first position that is closer to said front of said fuselage than said rear of said fuselage;
a rear port stabilator that is independently movable about a second axis, wherein said rear port stabilator extends from said port side of said fuselage at a second position that is closer to said rear of said fuselage than said front of said fuselage;
a forward starboard stabilator that is independently movable about a third axis, wherein said forward starboard stabilator extends from said starboard side of said fuselage at a third position that is closer to said front of said fuselage than said rear of said fuselage;
a rear starboard stabilator that is independently movable about a fourth axis, wherein said rear starboard stabilator extends from said starboard side of said fuselage at a fourth position that is closer to said rear of said fuselage than said front of said fuselage; and
wherein said first axis, said second axis, said third axis and said fourth axis are all perpendicular to both said longitudinal axis and said vertical axis, and wherein said forward port stabilator, said rear port stabilator, said forward starboard stabilator, and said rear starboard stabilator all have airfoil cross-sections that create varying amounts of lift and drag depending upon orientation relative to said downwash of air created by said rotor blades, wherein said forward port stabilator, said rear port stabilator, said forward starboard stabilator, and said rear starboard stabilator are selectively adjusted to create varying degrees of said lift and said drag within said downwash of air created by said rotor blades, therein providing said yaw, pitch and roll controls in flight.

2. (canceled)

3. The aircraft of claim 1, wherein said rotor blades can be selectively held stationary and positioned to produce a fixed wing mode of flight.

4. The aircraft of claim 3, further comprising a power unit that provides thrust and propels the aircraft forward in a direction along said longitudinal axis of said fuselage; and,
a yaw control surface mounted at said rear of the fuselage, so as to divert said thrust laterally.

5. (canceled)

6. (canceled)

7. (canceled)

8. (canceled

9. (canceled)

10. (canceled)

11. A method of controlling the motion and stability of an aircraft having a helicopter mode of flight, comprising:
providing a fuselage having a front, a rear, a port side, a starboard side, wherein said fuselage has a longitudinal axis that extends from said front to said rear, and a vertical axis that is perpendicular to said longitudinal axis of said fuselage;
providing rotor blades mounted such that when in said helicopter mode said rotor blades rotate about a rotational axis substantially parallel to said vertical axis, therein producing a downwash of air along said rotational axis that passes over and around said fuselage;
providing a forward port stabilator that is independently movable about a first axis, wherein said forward port stabilator extends from said port side of said fuselage at a first position that is closer to said front of said fuselage than said rear of said fuselage;
providing a rear port stabilator that is independently movable about a second axis, wherein said rear port stabilator extends from said port side of said fuselage at a second position that is closer to said rear of said fuselage than said front of said fuselage;
providing a forward starboard stabilator that is independently movable about a third axis, wherein said forward starboard stabilator extends from said starboard side of said fuselage at a third position that is closer to said front of said fuselage than said rear of said fuselage;
providing a rear starboard stabilator that is independently movable about a fourth axis, wherein said rear starboard stabilator extends from said starboard side of said fuselage at a fourth position that is closer to said rear of said fuselage than said front of said fuselage;
selectively adjusting said forward port stabilator, said rear port stabilator, said forward starboard stabilator, and said rear starboard stabilator within said downwash of air when said aircraft is in flight to provide said yaw, pitch and roll controls to said aircraft.

12. (canceled)

13. The method of claim 11, further comprising: providing a functional connection to said rotor blades such that said rotor blades are held stationary and said aircraft is changed from said helicopter mode of flight to a fixed wing mode of flight.

14. The method of claim 13, further comprising providing a power unit that in said fixed wing mode of flight provides thrust in a direction along said longitudinal axis of said fuselage; and, providing a yaw control surface mounted at said rear of the fuselage, said yaw control surface being a planar surface functionally connected to rotate about an axis parallel to the vertical axis of the fuselage so as to divert said thrust laterally.

15. (canceled)

16. (canceled)

17. (canceled)

18. (canceled)

19. (canceled)

20. (canceled)

21. The aircraft of claim 4, wherein when in said fixed wing mode of flight said forward port stabilator, said rear port stabilator, said forward starboard stabilator, and said rear starboard stabilator provide roll and pitch controls to said aircraft.
